(19) United States
(12) Patent Application Publication
(10) Pub. No.: US 2018/0202637 A1
(43) Pub. Date: Jul. 19, 2018

(54) MOUNTING SYSTEM FOR LIGHT FIXTURE

(71) Applicant: ABL IP Holding LLC, Decatur, GA (US)

(72) Inventors: Philip Sieczkowski, Lawrenceville, GA (US); David Zizzi, Atlanta, GA (US)

(73) Assignee: ABL IP Holding LLC, Decatur, GA (US)

(21) Appl. No.: 15/407,339

(22) Filed: Jan. 17, 2017

(51) Int. Cl. F21V 21/02; F21S 8/00; F21S 8/04; F21V 21/03; F21V 23/06; F21V 17/06

(52) U.S. Cl. CPC F21V 21/02; F21S 8/036; F21S 8/043; F21Y 2115/10; F21V 23/06; F21V 17/06; F21V 21/03

(57) ABSTRACT

A mounting system includes a housing, a mounting bracket, and a mounting plate for retaining the housing on a mounting surface, such as a wall or ceiling. The housing includes an inner surface and an outer surface. The inner surface defines a mounting feature having a flange aperture and a locking feature having a set screw aperture. The mounting bracket includes a body, a mounting portion, and a locking portion. The mounting portion extends from a first end of the body and is inserted within the flange aperture. The locking portion extends from the second, opposing end of the body and engages a set screw extending within the set screw aperture.

### FIELD OF THE INVENTION

Embodiments of the invention relate to a light fixture, and more specifically a mounting mechanism and method for mounting the light fixture to a wall or ceiling.

### BACKGROUND

Light emitting diode (LED) light fixtures generally include a housing, a LED printed circuit board (PCB) (that includes at least one LED) provided within the housing, and an optic coupled to the housing to disperse light generated by the at least one LED as desired. LEDs are typically (but not always) driven with direct current (DC) and circuitry can be provided on the PCB to convert the incoming alternating current (AC) into DC. Because installation of the fixture oftentimes can require access to the compartment of the fixture in which the PCB resides, protective barriers are often required on such fixtures to reduce the risk of inadvertent contact with the circuitry by an installer.

### SUMMARY

The subject matter of examples of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to some embodiments, a mounting system includes a housing, a mounting bracket, and a mounting plate for retaining the housing on a mounting surface, such as a wall or ceiling. The housing includes an inner surface and an outer surface. The inner surface defines a mounting feature having a flange aperture and a locking feature having a set screw aperture. The mounting system includes a mounting bracket and a mounting plate. The mounting bracket includes a body, a mounting portion, and a locking portion. The mounting portion extends from a first end of the body and is inserted within the flange aperture. The locking portion extends from the second, opposing end of the body and engages a set screw extending within the set screw aperture.

According to various embodiments, a method of installing the housing on a surface includes securing the mounting system to the surface and mounting the housing on the mounting system. Mounting the housing on the mounting system includes: aligning the distal flange of the mounting bracket with the flange aperture of the mounting feature defined by the inner surface of the housing; inserting the distal flange into the flange aperture; pivoting the housing towards the surface and positioning the locking portion of the mounting bracket adjacent the locking feature defined by the inner surface of the housing; and securing the housing to the mounting bracket.

Various implementations described in the present disclosure can include additional systems, methods, features, and advantages, which can not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a top perspective view of an LED light fixture according to various embodiments.

FIG. 2 is a side elevation view of the LED light fixture of FIG. 1.

FIG. 3 is a top plan view of the LED light fixture of FIG. 1.

FIG. 4 is a cross-sectional view taken along the line FIG. 4—FIG. 4 in FIG. 3.

FIG. 5 is a partially exploded perspective view of a mounting system according to various embodiments, the mounting system including a mounting plate and a mounting bracket.

FIG. 6 is a top perspective view of the mounting bracket of the mounting system of FIG. 5.

FIG. 7 is another top perspective view of the mounting bracket of the mounting system of FIG. 5.

FIG. 8 is a top plan view of the mounting bracket of the mounting system of FIG. 5.

FIG. 9 is a partially exploded assembly view of the light fixture of FIG. 1 and the mounting system of FIG. 5.

FIG. 10 is a top perspective view of the light fixture of FIG. 1 mounted on the mounting system of FIG. 5.

FIG. 11 is a bottom plan view of the light fixture of FIG. 1 mounted on the mounting system of FIG. 5.

### DETAILED DESCRIPTION

The subject matter of examples of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Examples of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

Embodiments of the present invention are directed to a mounting system for light fixtures and methods of employing the mounting system to align and secure the light fixture for wall or ceiling installation. Such mounting systems reduce the risk of injury due to contact with the PCB and eliminate the need for the additional barrier by forgoing the need to access the compartment of the LED light fixture containing the PCB or any other electrically charged components during installation. It should be understood, however, that while LED light fixtures are discussed herein, the mounting system disclosed herein is not limited for use with only LED light fixtures. Rather, it can be used with any type of surface mounted fixture, regardless of the light source within the fixture.

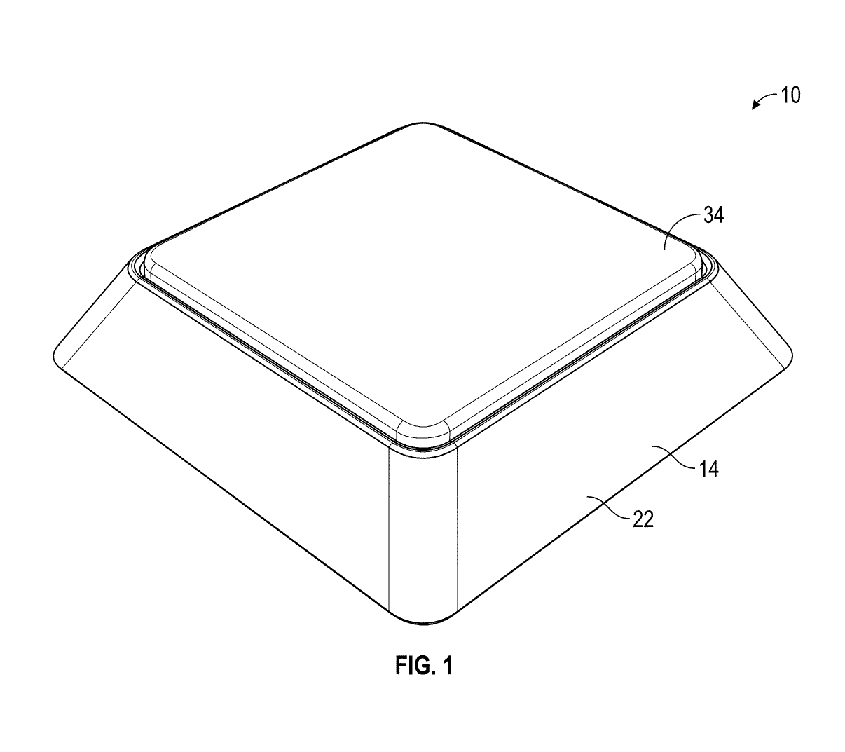

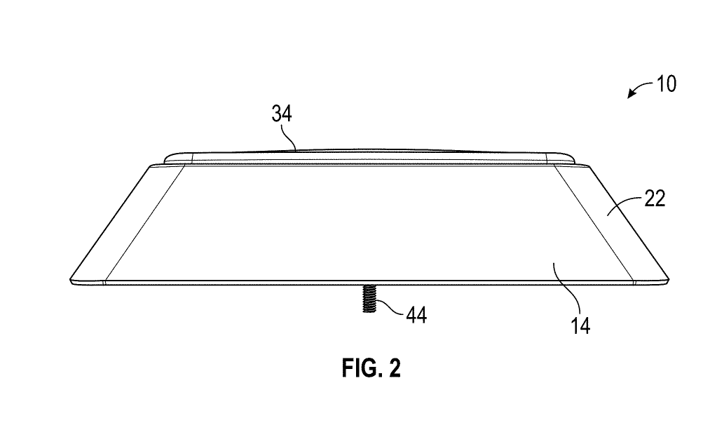

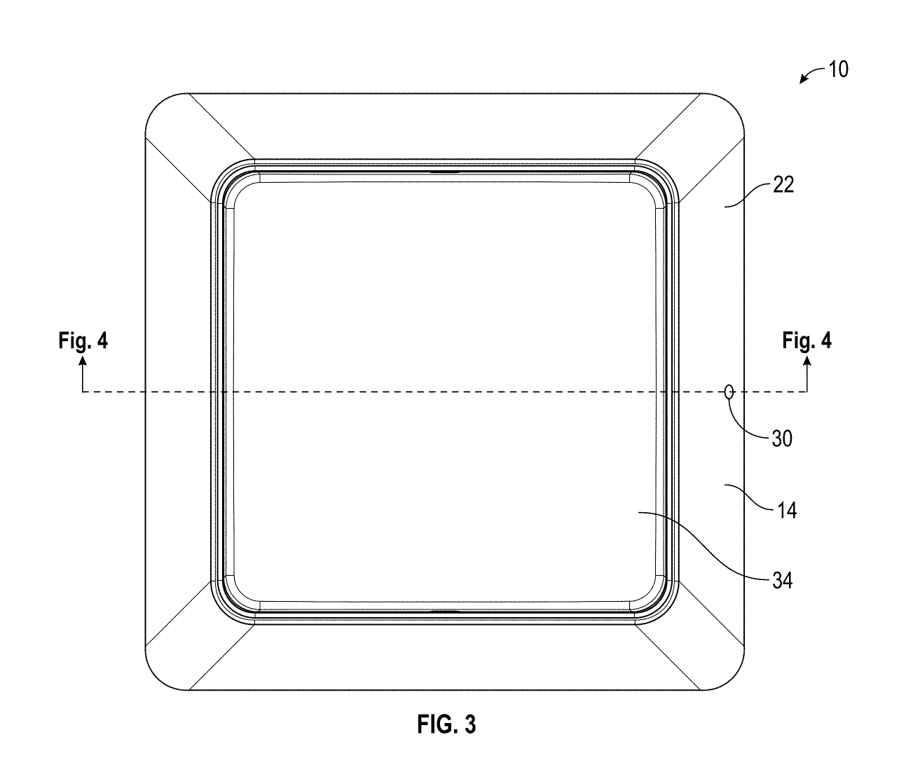

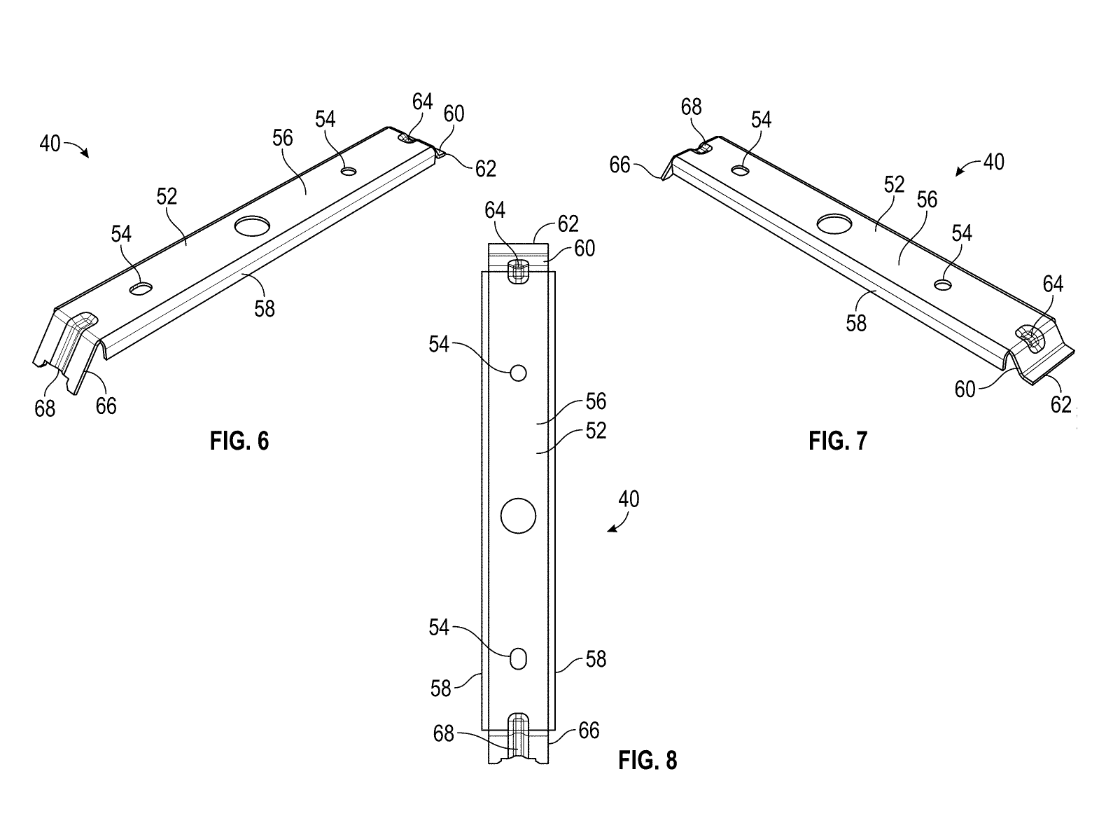

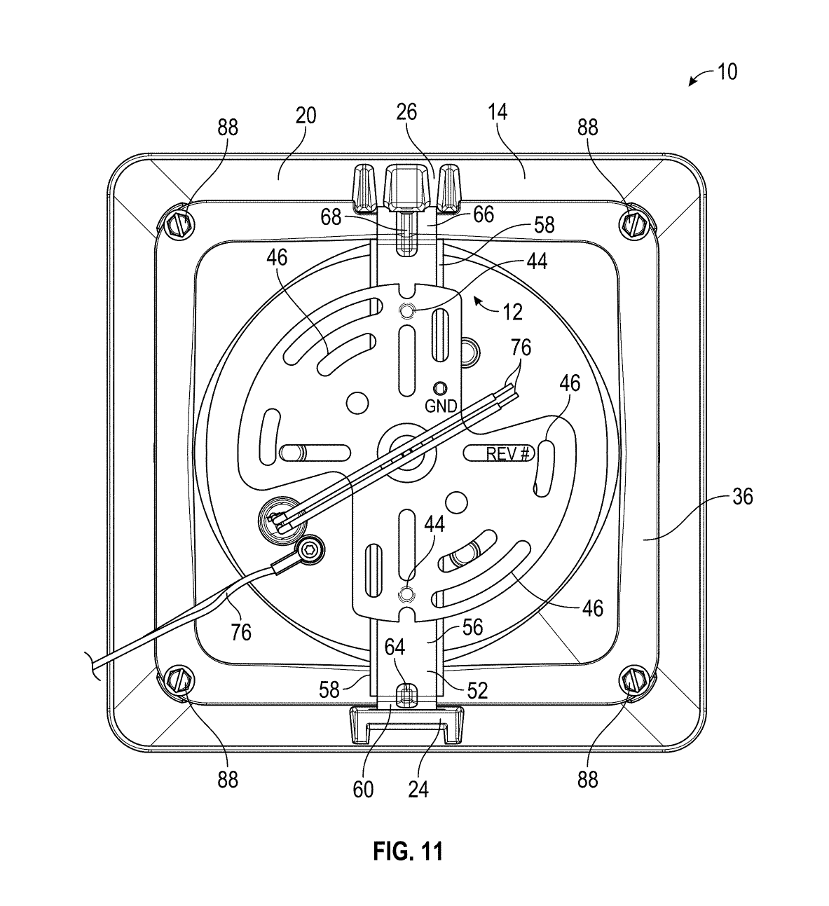

FIGS. 1-11 illustrate embodiments of a light fixture 10 with a mounting system 12 (see FIG. 5) for aligning and securing the light fixture 10 on a surface, such as a wall or a ceiling, during installation. Although the mounting system 12 is described below with the light fixture 10, it will be appreciated that the mounting system 12 are not limited to use with light fixtures. In other examples, the mounting system 12 may be used with various other non-lighting or non-illuminating components or housings of any kind that are to be mounted on a surface. For example, in some embodiments, the mounting system 12 may be used to support a non-illuminating component of a lighting system. In some of these embodiments, the mounting system 12 may indirectly support the light fixture 10 if the light fixture 10 is attached to the non-illuminating component, although it need not. As one non-limiting example, the mounting system 12 may support an emergency battery backup unit on a surface, and the light fixture 10 may be attached to the emergency battery backup unit. In other embodiments, the mounting system 12 may be used with various other types of housings or non-illuminating parts, which may or may not be part of a lighting system, that are mounted to a surface, such as emergency battery backup units, controls, etc. that are mounted on a surface.

The light fixture 10 includes a housing 14, which may be cast, molded, or otherwise formed to have any desired shape. Embodiments of the mounting system 12 described herein are particularly suitable for use with square fixtures (i.e., the housing 14 is square). The housing 14 includes an inner surface 20 and an outer surface 22.

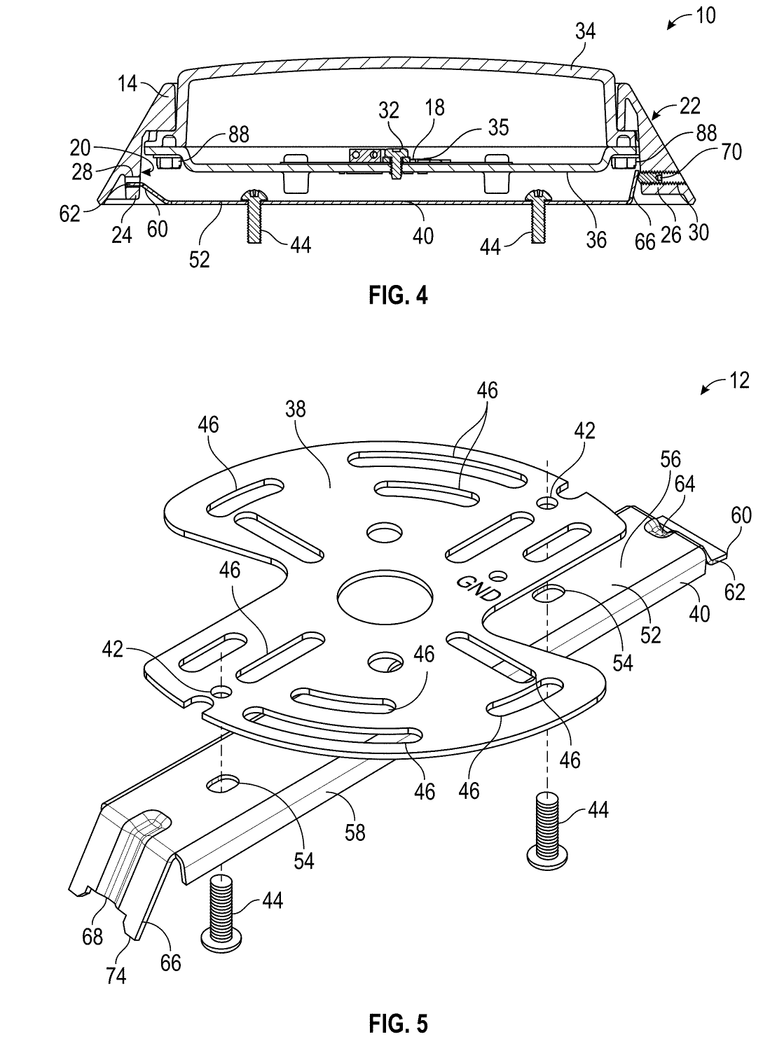

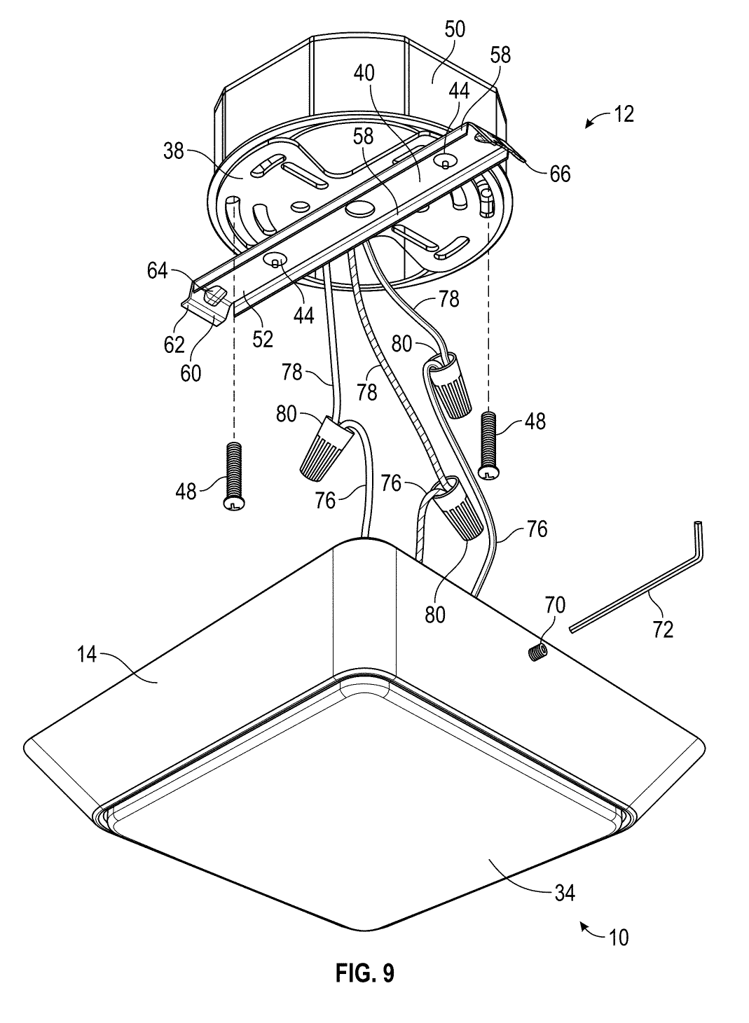

The inner surface 20 of the housing 14 defines a mounting feature 24 and a locking feature 26 opposite the mounting feature 24. The mounting feature 24 includes a flange aperture 28, which is dimensioned and configured to accommodate an end of a flange 62 of a mounting bracket 40 of the mounting system 12, as described in detail below. The locking feature 26 defines a set screw aperture 30, which is dimensioned to accommodate a set screw 70 (see FIGS. 4 and 9), as described in detail below. In some cases, the set screw aperture 30 includes internal threads for interdigitating with the threads on the set screw 70. In some cases, the set screw aperture 30 extends from the inner surface 20 to the outer surface 22 of the housing 14.

The LEDs 35 are mounted on a support plate 36. The support plate 36 may be coupled to the housing 14 (such as via fasteners 88 such as screws, bolts, pins, adhesives, clips, clasps, snap-fitting, etc.) or may be formed integrally with the housing 14. Necessary wiring (incoming power, ground, etc.) may be attached or extend through the support plate 36.

The LEDs 35 may be provided on a PCB 18, which is mounted to the support plate 36 (such as via fasteners 32, such as screws, bolts, pins, etc.). Alternatively, the LEDs 35 may be chip-on-board LEDs 35 that are provided directly on the support plate 36. Any number of PCBs 18 and/or leds 35 may be provided. The LEDs 35 may be single-die or multi-die leds 35, DC or AC, or can be organic leds 35. White, color, or multicolor LEDs 35 may be used. Moreover, the leds 35 need not be all the same color; rather, mixtures of LEDs 35 may be used.

An optic 34 is provided over the LEDs 35 to control the distribution of light emitted from the LEDs 35. Any number or type of optic 34 may be used, including, but not limited to, extruded or molded lenses, diffusers, collimators, etc. The optic 34 can be made of any non-metallic material that permits light to exit through the optic 34, such as, but not limited to, polymeric materials, silicone, etc. In various examples, the optic 34 is coupled to the housing 14 through snap-fitting. However, in various other embodiments, the optic 34 may be secured to the housing 14 through various other suitable mounting mechanisms including, but not limited to, screws, nuts and bolts, adhesives, pins, clips, clasps, etc. By way only of example, in the illustrated embodiment (see FIG. 4), the optic 34 is secured to the housing 14 via the same fasteners 88 that secure the support plate 36 to the housing 14.

Referring to FIGS. 5-8, the mounting system 12 includes a mounting plate 38 and a mounting bracket 40. In the present example, the mounting plate 38 and the mounting bracket 40 are separate components that are coupled together. However, in various other examples, the mounting plate 38 and the mounting bracket 40 may be integrally formed as a monolithic component through molding, casting, or various other suitable forming techniques. The mounting plate 38 includes securing apertures 42 that are dimensioned to accommodate fasteners 44, such as bolts, screws, pins, clasps, clips, etc., which couple the mounting bracket 40 to the mounting plate 38. The securing apertures 42 may be circular in shape or may be other geometrical shapes, such as arcs, that expand the relative positions in which the mounting bracket 40 and the mounting plate 38 can be secured together. The mounting plate 38 also includes mounting apertures 46 that are dimensioned to accommodate fasteners 48 to mount the mounting plate 38 (and attached mounting bracket 40) to a junction box 50 (see FIG. 9). Similar to the securing apertures 42, the apertures 46 may be circular in shape or may be other geometrical shapes, such as arcs, that expand the relative positions in which the mounting plate 38 and mounting bracket 40 can be secured to the junction box 50 or other mounting surface (wall, ceiling, etc.). In various cases, the mounting plate 38 may have any suitable shape for attachment to the mounting surface.

The mounting bracket 40 includes a body 52 having securing apertures 54 that are dimensioned to accommodate the fasteners 44. The securing apertures 54 may be circular in shape or may be other geometrical shapes. For example and without limitation, in the present example, one or more of the securing apertures 54 has an elongated shape that permits minor relative movement between the mounting bracket 40 and mounting plate 38. When the mounting system 12 is assembled, the securing apertures 54 may align with the securing apertures 42. In some embodiments, the body 52 includes a mounting surface 56 that abuts the mounting plate 38 when the mounting system 12 is assembled. In some embodiments, the mounting surface 56 is substantially planar, although it need not be. In some embodiments, the mounting bracket 40 includes opposing side portions 58 extending from the body 52. In some cases, the side portions 58 extend substantially perpendicular to the mounting surface 56, although they need not be.

The mounting bracket 40 includes a mounting portion 60 extending from one end of the body 52. The mounting portion 60 extends at an angle from the body 52 relative to the mounting surface 56. In some embodiments, the mounting portion 60 may extend at a non-zero angle such that the mounting portion 60 and mounting surface 56 are not coplanar. In other embodiments, the mounting portion 60 and the mounting surface 56 are substantially parallel. As best illustrated in FIG. 7, the mounting portion 60 includes a distal flange 62. In some cases, the distal flange 62 and the mounting surface 56 extend in substantially parallel planes, although they need not. The distal flange 62 is configured for insertion within the flange aperture 28 of the mounting feature 24, as described in detail below. In some cases, the mounting portion 60 also includes a strengthening embossment 64, although it need not. In some cases, at least a portion of the body 52 of the mounting bracket 40 may also define a portion of the strengthening embossment 64.

The mounting bracket 40 also includes a locking portion 66 extending from the opposing end of the body 52. Similar to the mounting portion 60, the locking portion 66 extends from the body 52 at a zero or non-zero angle relative to the mounting surface 56. In some cases, the locking portion 66 and the mounting portion 60 extend at the same angle relative to the mounting surface 56, although they need not. The locking portion 66 is configured to engage with a set screw 70 that is positioned within the set screw aperture 30 of the locking feature 26. In some cases, similar to the mounting portion 60, the locking portion 66 defines a strengthening embossment 68. In various examples, at least a portion of the body 52 of the mounting bracket 40 may also defined a portion of the strengthening embossment 68.

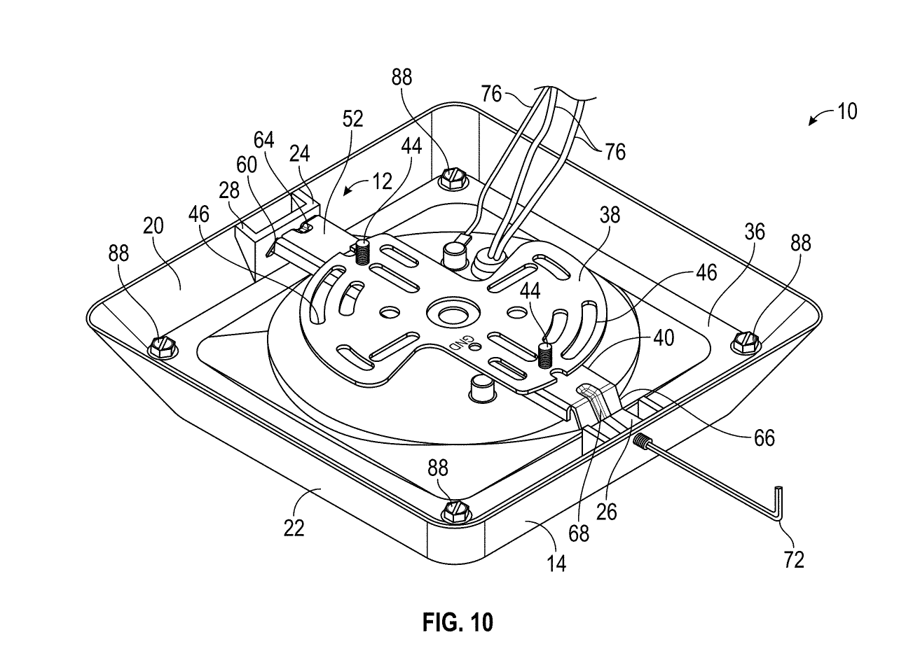

Referring to FIGS. 10-12, to install the light fixture 10 with the mounting system 12, an installer secures the mounting bracket 40 to the mounting plate 38 with the fasteners 44. The assembled mounting system 12 is oriented at a desired configuration relative to the junction box 50, and the mounting system 12 is secured to the junction box 50 with fasteners 48. In some cases, a single set of fasteners (e.g. the fasteners 44) may both secure the mounting bracket 40 to the mounting plate 38 and the mounting plate 38 to the junction box 50. In some cases, the wiring 76 for the light fixture 10, which may include power supply wiring, ground wiring, etc., is connected to corresponding wiring 78 of the junction box 50 through connectors 80 or other suitable connectors before the light fixture 10 is mounted on the mounting system 12.

To attach the light fixture 10 to the mounting system 12, the set screw 70 is inserted into the set screw aperture 30 to a certain extent. In some cases, a tool 72 (such as a screwdriver, Allen wrench, etc.) may optionally be used to insert the set screw 70 into the set screw aperture 30. The distal flange 62 of the mounting portion 60 of the mounting bracket 40 is aligned with the flange aperture 28 of the mounting feature 24, and the flange 62 is inserted into the flange aperture 28. After the flange 62 is inserted into the flange aperture 28, the light fixture 10 is pivoted towards the junction box 50 as far as possible such that the set screw aperture 30 of the locking feature 26 is adjacent the locking portion 66 of the mounting bracket 40. After the light fixture 10 is positioned, the set screw 70 is further installed such that an end of the set screw 70 engages the locking portion 66 of the mounting bracket 40 (more specifically, embossment 68 of locking portion 66) to secure the light fixture 10 to the mounting bracket 40 and draw the light fixture 10 towards the mounting surface (e.g., ceiling, wall, etc.)

The mounting system 12 disclosed herein may be particularly suitable for use with rectangular, square or other rectilinear fixtures. Unlike circular fixtures that appear the same when mounted in any rotational orientation on a mounting surface, more care often must be given when installing rectilinear fixtures. More specifically, it is often necessary or desirable to align the edges of rectilinear fixtures with other straight edges in the installation environment. For example, the edges of a square fixture mounted on a ceiling or a wall often must be aligned with the straight edges formed between adjacent walls and/or between the ceiling and the walls. Embodiments of the mounting system 12 disclosed herein permit such alignment with relative ease. The mounting bracket 40 can be secured at a position on the mounting plate 38 that will ensure that the light fixture 10, when mounted on the mounting bracket 40, will be oriented as desired on the mounting surface. Adjustments may be made to the orientation of the light fixture 10 by simply disengaging the light fixture 10 from the mounting bracket 40, adjusting the orientation of the mounting bracket 40, and then re-mounting the light fixture 10 on the mounting bracket 40. All of this can be accomplished without having to access the interior of the light fixture 10 and thus without exposing the installer to the perils that lie therein. However, while the mounting system 12 is particularly useful with rectilinear fixtures, it can be used with fixtures of any shape.

Different arrangements of the components depicted in the drawings or described above, as well as components and steps not shown or described are possible. Similarly, some features and sub-combinations are useful and may be employed without reference to other features and sub-combinations. Examples of the invention have been described for illustrative and not restrictive purposes, and alternative examples will become apparent to readers of this patent. Accordingly, the present invention is not limited to the examples described above or depicted in the drawings, and various examples and modifications may be made without departing from the scope of the claims below.

That which is claimed is:

1. A mounting system comprising:
a housing having an inner surface and an outer surface, the inner surface defining a mounting feature and a locking feature, the mounting feature comprising a flange aperture and the locking feature comprising a set screw aperture;
a mounting bracket comprising a body having a first end, a second end opposite the first end, a mounting surface, a mounting portion extending from the first end and configured for insertion within the flange aperture, and a locking portion extending from the second end and configured for positioning adjacent the locking feature; and
a mounting plate.

2. The mounting system of claim 1, wherein the mounting portion of the mounting bracket further comprises a mounting portion strengthening embossment and wherein the locking portion of the mounting bracket further comprises a locking portion strengthening embossment.

3. The mounting system of claim 1, wherein the mounting portion extends at an angle from the first end of the body and comprises a distal flange configured for insertion within the flange aperture and wherein the locking portion extends at an angle from the second end of the body.

4. The mounting system of claim 3, wherein the angle at which the mounting portion extends from the body of the mounting bracket is substantially similar to the angle at which the locking portion extends from the body of the mounting bracket.

5. The mounting system of claim 3, wherein the distal flange extends at an angle from the mounting portion.

6. The mounting system of claim 5, wherein the distal flange extends in a plane that is substantially parallel to the mounting surface.

7. The mounting system of claim 1, wherein the set screw aperture extends from the inner surface to the outer surface of the housing.

8. The mounting system of claim 1, wherein the mounting plate is coupled to the mounting bracket through fasteners.

9. The mounting system of claim 1, wherein the housing is rectangular, wherein the mounting feature is defined on the inner surface of a first side of the housing, and wherein the locking feature is defined on the inner surface of a second side of the housing opposite the first side.

10. The mounting system of claim 1, wherein the mounting plate comprises bracket-mounting apertures and junction box-mounting apertures, and wherein the junction box-mounting apertures define at least two configurations to mount the mounting plate to a junction box.

11. The mounting system of claim 1, wherein the housing is a light emitting diode (LED) housing of an LED light fixture.

12. A method of installing a housing on a surface comprising:
securing a mounting system to the surface, the mounting system comprising a mounting bracket and a mounting plate, the mounting bracket comprising a body, a mounting portion, and a locking portion; and
mounting the housing on the mounting system by:
inserting the mounting portion of the mounting bracket into a flange aperture of a mounting feature defined by an inner surface of the housing;
pivoting the housing towards the surface and positioning the locking portion of the mounting bracket adjacent a locking feature defined by the inner surface of the housing; and
securing the housing to the mounting bracket.

13. The method of installing the housing on the surface of claim 12, wherein securing the housing to the mounting bracket comprises inserting a set screw into a set screw aperture defined by the locking portion and engaging the set screw with the locking portion of the mounting bracket.

14. The method of installing the housing on the surface of claim 13, wherein the locking portion comprises a locking portion strengthening embossment, and wherein engaging the set screw with the locking portion comprises engaging the set screw with the locking portion strengthening embossment.

15. The method of installing the housing on the surface of claim 12, wherein the housing is rectangular, and wherein the method further comprises orienting the mounting system at a predetermined configuration relative to the surface such that edges of the housing are at a predetermined orientation on the surface.

16. The method of installing the housing on the surface of claim 12, wherein the surface comprises a junction box, and wherein securing the mounting system to the surface comprises securing the mounting system to the junction box with fasteners.

17. The method of installing the housing on the surface of claim 16, wherein the housing is a light emitting diode (LED) housing of an LED light fixture.

18. The method of installing the housing on the surface of claim 17, further comprising connecting wiring of the LED light fixture with wiring of the junction box prior to mounting the housing on the mounting system.

19. The method of installing the housing on the surface of claim 12, further comprising coupling the mounting bracket to the mounting plate through fasteners prior to securing the mounting system on the surface.

20. The method of installing the housing on the surface of claim 12, wherein the mounting portion comprises a distal flange and wherein inserting the mounting portion of the mounting bracket into the flange aperture comprises inserting the distal flange of the mounting bracket into the flange aperture.
